(19) United States
(12) Patent Application Publication
(10) Pub. No.: US 2026/0225501 A1
(43) Pub. Date: Aug. 6, 2026

(54) SLIDING DEVICE

(71) Applicant: TOYOTA BOSHOKU KABUSHIKI KAISHA, Aichi (JP)

(72) Inventors: Kazuki INOUE, Miyoshi-shi (JP); Daishi YAGUCHI, Obu-shi (JP); Motohisa NAKAMURA, Hashima-gun (JP); Yuki KUROYANAGI, Nagoya-shi (JP)

(73) Assignee: TOYOTA BOSHOKU KABUSHIKI KAISHA, Aichi (JP)

(21) Appl. No.: 19/453,625

(22) Filed: Jan. 20, 2026

(30) Foreign Application Priority Data
Feb. 6, 2025 (JP) 2025-018388

(51) Int. Cl. B60N 2/08; B60N 2/07

(52) U.S. Cl. CPC B60N 2/0843; B60N 2/0705; B60N 2/0818

(57) ABSTRACT

A sliding device for a seat includes a fixed rail provided with two or more fitting holes, a movable rail to be slidably coupled to the fixed rail, a first latch displaceable between a locked position thereof and an unlocked position thereof, a second latch displaceable between a locked position thereof and unlocked positions thereof, a first spring configured to exert an elastic force for retaining the first latch in the locked position thereof, and a second spring configured to exert an elastic force for retaining the second latch in the locked position thereof.

### CROSS-REFERENCE TO RELATED APPLICATIONS

This application claims the benefit of Japanese Patent Application No. 2025-018388 filed on Feb. 6, 2025 with the Japan Patent Office, and the entire disclosure of Japanese Patent Application No. 2025-018388 is incorporated herein by reference.

### BACKGROUND

The present disclosure relates to a sliding device for slidably supporting a seat.

For example, in a sliding device described in Japanese Unexamined Patent Application Publication No. 2007-145144, multiple locking pawls are engaged with engagement holes provided in a fixed rail, thereby inhibiting a movable rail from sliding relative to the fixed rail. An inclined portion having a tapered shape is provided on a root side of each of the locking pawls.

### SUMMARY

In the above-described configuration, a spring is necessary for retaining the multiple locking pawls at positions where the locking pawls fit with the engagement holes (hereinafter, referred to as “fitting positions”). This spring causes the locking pawls to accelerate and displace from positions where the locking pawls are spaced apart from the engagement holes (hereinafter, referred to as “non-fitting positions”) toward the fitting positions.

As a displacement stroke increases from the non-fitting positions to the fitting positions, speed at which the locking pawls enter fitting holes (hereinafter, referred to as “entry speed”) increases.

Furthermore, as the entry speed increases, a kinetic energy of the locking pawls increases, resulting in a greater impact when the locking pawls enter the fitting holes. The present disclosure discloses an example of a sliding device in light of this point.

It is desirable that a sliding device for slidably supporting a seat according to one aspect of the present disclosure comprises, for example, at least one of elements described below.

Specifically, the elements are: a fixed rail that is immovable and that is provided with two or more fitting holes arranged along a longitudinal direction; a movable rail slidably coupled to the fixed rail and configured such that a seat is attachable to the movable rail; a first latch coupled to the movable rail so as to be displaceable between a locked position where the first latch engages with first one of the fitting holes and an unlocked position where the first latch is disengaged from the first one of the fitting holes, the first latch including an inclined portion that has a tapered shape and that is brought into contact with an inner circumferential surface of the first one of the fitting holes when the first latch is located in the locked position; at least one second latch coupled to the movable rail so as to be displaceable between a locked position where the second latch engages with second one of the fitting holes and an unlocked position where the second latch is disengaged from the second one of the fitting holes, the second latch being displaceable independently from the first latch; a first spring configured to exert an elastic force for retaining the first latch in the locked position thereof; and a second spring configured to exert an elastic force for retaining the second latch in the locked position thereof.

It is desirable that a length of the first latch is smaller than a length of the second latch, and when the second latch is located in the locked position thereof, the second latch is not in contact with an inner circumferential surface of the second one of the fitting holes.

This can reduce a displacement stroke of the first latch in the sliding device. Accordingly, entry speed of the first latch can be small, and therefore, an impact when the first latch enters the fitting hole can be small. Further, since the second latch is not in contact with the inner circumferential surface of the fitting hole, the impact when the second latch enters the fitting hole can be sufficiently small.

The sliding device may also have the following configuration.

Specifically, it is desirable that the movable rail includes a one-side portion and a different-side portion each facing a fitting portion, which is a portion of the fixed rail where the fitting holes are provided, from both sides of the fitting portion, the one-side portion and the different-side portion being respectively provided with engagement holes configured to allow the first latch and the second latch to penetrate, when the first latch is located in the locked position thereof, the first latch penetrates the first one of the fitting holes and first one of the engagement holes in the one-side portion, and when the second latch is located in the locked position thereof, the second latch penetrates the second one of the fitting holes, second one of the engagement holes in the one-side portion, and third one of the engagement holes in the different-side portion.

It is desirable that the first latch is smaller in number than the second latches. This can reduce the mass of a member constituting the first latch, surely reducing the impact when the first latch enters the fitting hole.

It is desirable that the sliding device comprises a bracket fixed to the movable rail, the bracket including a shaft configured to support the first latch and the second latch such that the first latch and the second latch are individually rotatable between the locked positions thereof and the unlocked positions thereof. This can reduce the number of components of the sliding device or can suppress increase in the number of the components.

It is desirable that the sliding device further comprises a first retaining portion that is provided at the first latch and that includes a shaft hole through which the shaft passes, and a second retaining portion that is provided at the second latch and that includes a shaft hole into which the shaft fits, wherein a portion of the second retaining portion where the shaft hole of the second retaining portion is provided is located on a side opposite from the bracket across a portion of the first retaining portion where the shaft hole of the first retaining portion is provided.

Thus, a large external force acting on the movable rail is first input to the first retaining portion via the bracket. Subsequently, after the first latch, the first retaining portion, and the fitting hole with which the first latch engages are deformed, the external force is input to the second retaining portion. As a result, an energy due to the large external force acting on the movable rail can be reliably absorbed.

It is desirable that the elastic force of the first spring for retaining the first latch in the locked position thereof is smaller than the elastic force of the second spring for retaining the second latch in the locked position thereof. This can reduce the operation force for displacing the first latch and the second latch to the unlocked positions thereof.

It is desirable that when the first latch and the second latch are displaced from the locked positions thereof to an unlocked position side, the second latch is first displaced to a specific position on the unlocked position side, and subsequently, the first latch and the second latch are integrally displaced to the unlocked position side. Accordingly, it is possible to reliably reduce the operation force for displacing the first latch and the second latch to the unlocked positions.

### BRIEF DESCRIPTION OF THE DRAWINGS

Example embodiments of the present disclosure will be described hereinafter with reference to the accompanying drawings, in which:

FIG. 1 is a perspective view of a sliding device according to a first embodiment;

FIG. 2 is an exploded perspective view of the sliding device according to the first embodiment;

FIG. 3 is a perspective view of a locking mechanism according to the first embodiment;

FIG. 4 is a perspective view of a fixed rail according to the first embodiment;

FIG. 5 is a perspective view of a movable rail according to the first embodiment;

FIG. 6 is a diagram showing fitting holes and engagement holes according to the first embodiment;

FIG. 7 is a diagram showing the locking mechanism and the like according to the first embodiment;

FIG. 8 is a diagram showing the locking mechanism and the like according to the first embodiment;

FIG. 9 is a diagram showing a first latch, second latches, and the like according to the first embodiment;

FIG. 10 is a perspective view of the locking mechanism according to the first embodiment;

FIG. 11 is a perspective view of the locking mechanism according to the first embodiment;

FIG. 12 is a perspective view of the locking mechanism according to the first embodiment; and

FIG. 13 is a diagram showing the first latch, the second latches, and the like according to the first embodiment.

### DETAILED DESCRIPTION OF EXEMPLARY EMBODIMENTS

The following embodiments of the invention are examples of embodiments that belong to the technical scope of the present disclosure. In other words, matters specifying the invention recited in the claims are not limited to the specific configurations or structures shown in the following embodiments.

The present embodiment is an example in which a sliding device according to the present disclosure is applied to a sliding device that supports a vehicle seat. Direction-indicating arrows, hatched lines, and the like in the figures are provided for easier understanding of relationships among the figures and the shapes of members or portions of the sliding device.

Thus, the sliding device is not limited by the directions shown in the drawings. The directions shown in the drawings are based on a state where the sliding device according to the present embodiment is mounted on a vehicle. The drawings with hatched lines provided thereon are not necessarily cross-sectional views.

A member or portion described at least with a reference numeral is provided in at least one except in a case of being accompanied by restrictive words such as “only one”. In other words, the member or portion may be provided in two or more unless accompanied by the restrictive words such as “only one”. The sliding device disclosed in the present disclosure comprises at least one of elements such as a member or portion described at least with a reference numeral or a structural part illustrated.

### First Embodiment

### Overview of Sliding Device

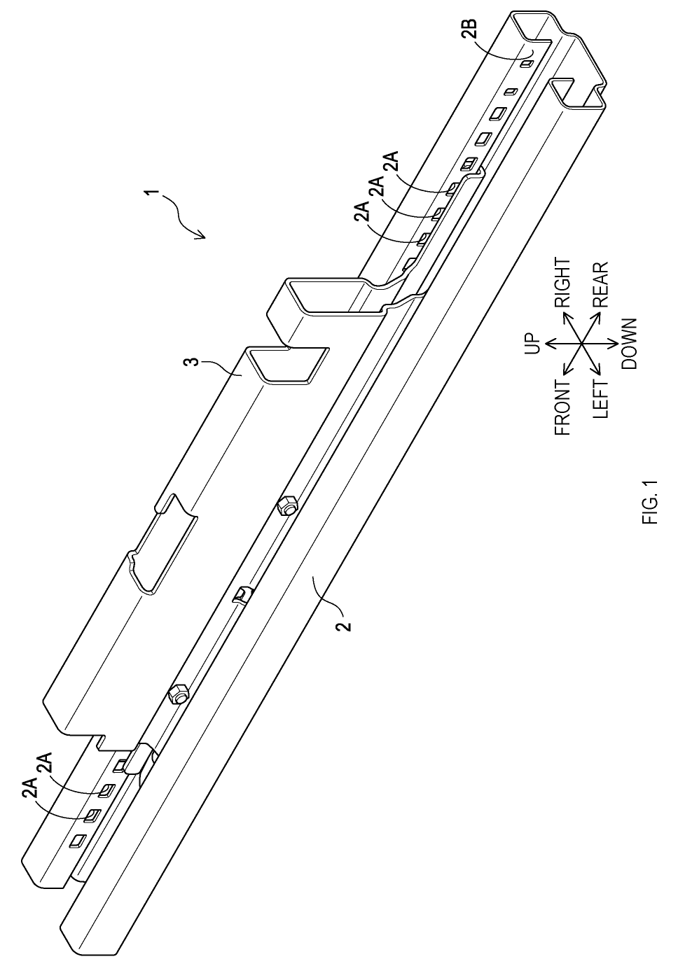

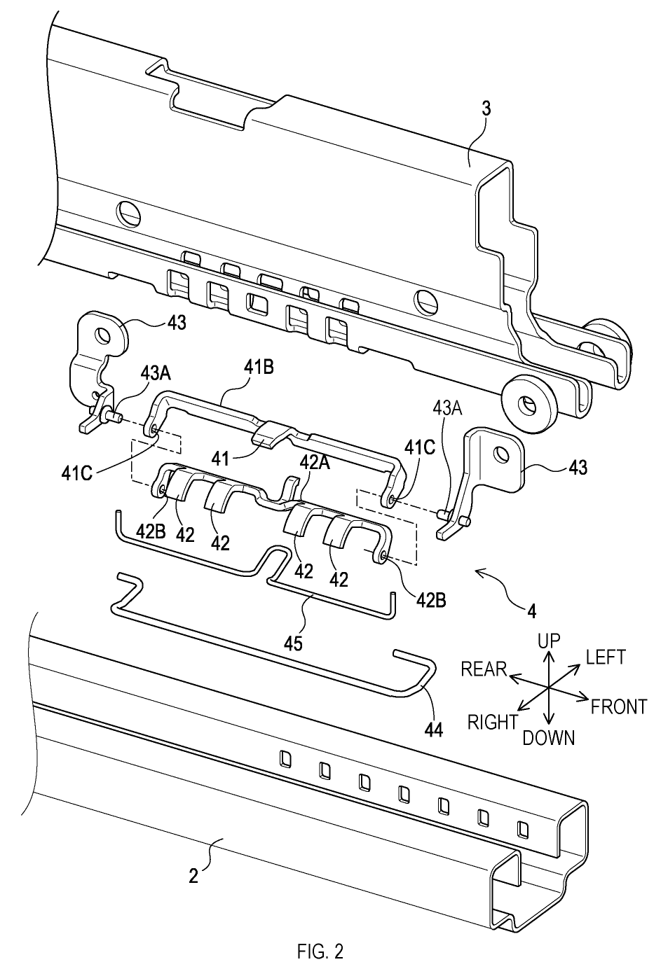

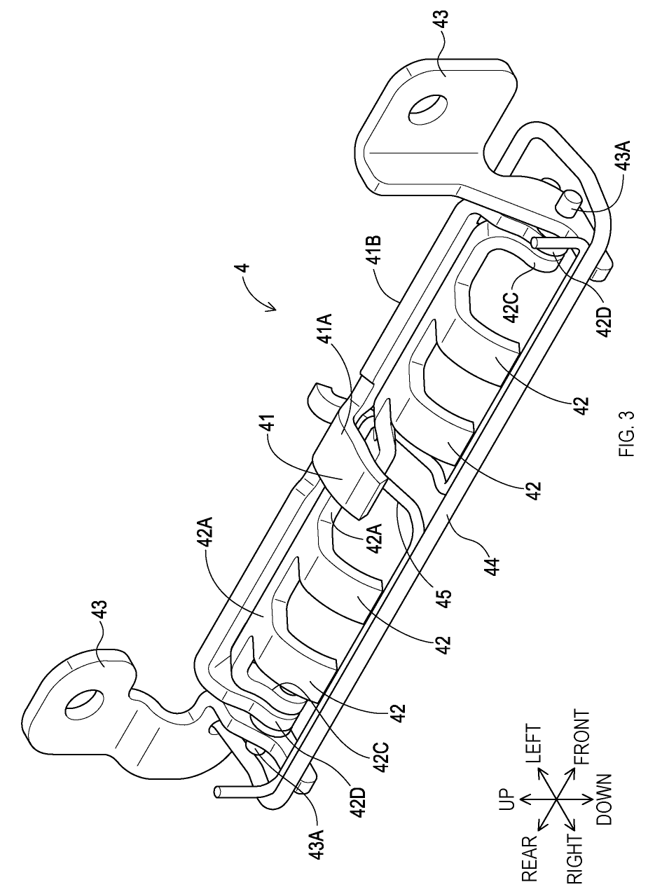

A sliding device 1 according to the present embodiment, shown in FIG. 1, is a device for slidably supporting a seat to be mounted in a vehicle (hereinafter, referred to as a “vehicle seat”). As shown in FIG. 2, the sliding device 1 comprises at least a fixed rail 2, a movable rail 3, and a locking mechanism 4 (see FIG. 3), and the like.

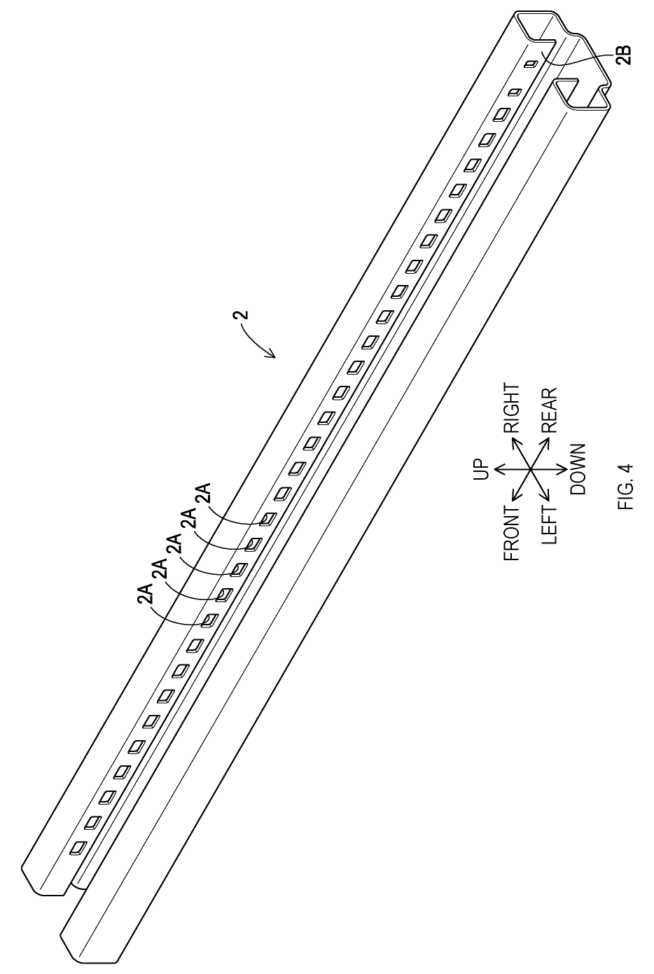

The fixed rail 2 is an immovable rail member directly or indirectly fixed to a vehicle. As shown in FIG. 4, the fixed rail 2 is provided with multiple fitting holes 2A. These fitting holes 2A are arranged in series along a longitudinal direction of the fixed rail 2.

As shown in FIG. 1, a portion 2B (hereinafter, referred to as a “fitting portion” 2B) where the multiple fitting holes 2A are provided is a portion facing lower portions of the movable rail 3 in left-right directions. Each of the fitting holes 2A is formed as a through hole that penetrates through the fitting portion 2B in the left-right directions.

The movable rail 3 is a member slidably coupled to the fixed rail 2. A vehicle seat (not shown) is to be attached to the movable rail 3. Thus, the vehicle seat can be slidably supported by the sliding device 1.

The locking mechanism 4 is a mechanism for switching between a “state where the movable rail 3 is slidable relative to the fixed rail 2 (hereinafter, referred to as a “unlocked state”)” and a “state where the movable rail 3 is prohibited from sliding relative to the fixed rail 2 (hereinafter, referred to as a “locked state”).

### Details of Locking Mechanism and the like

### Configuration of Locking Mechanism and the like

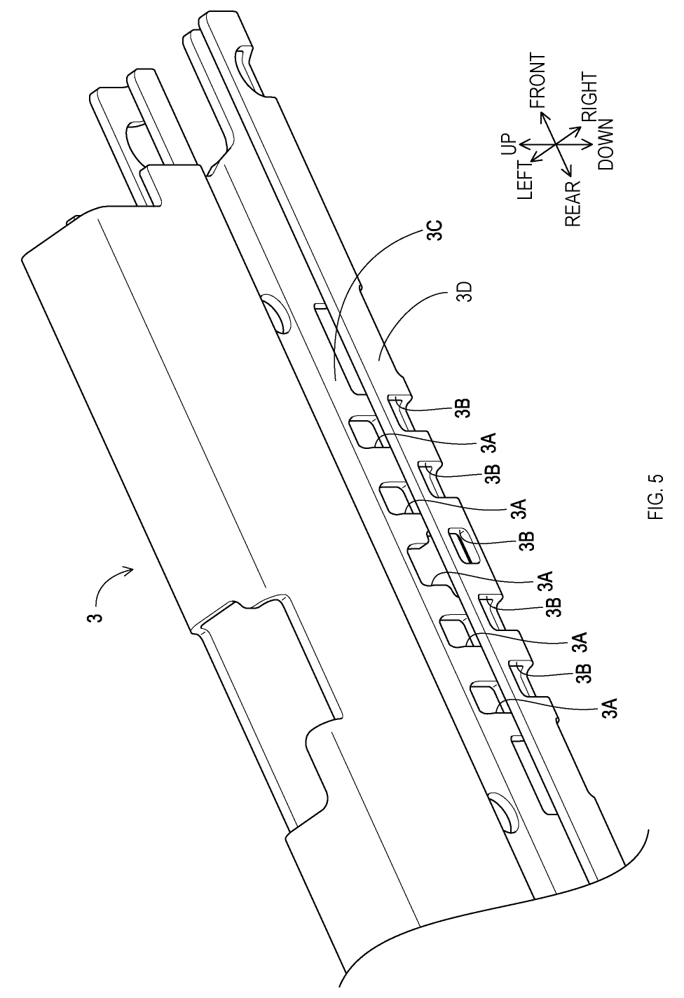

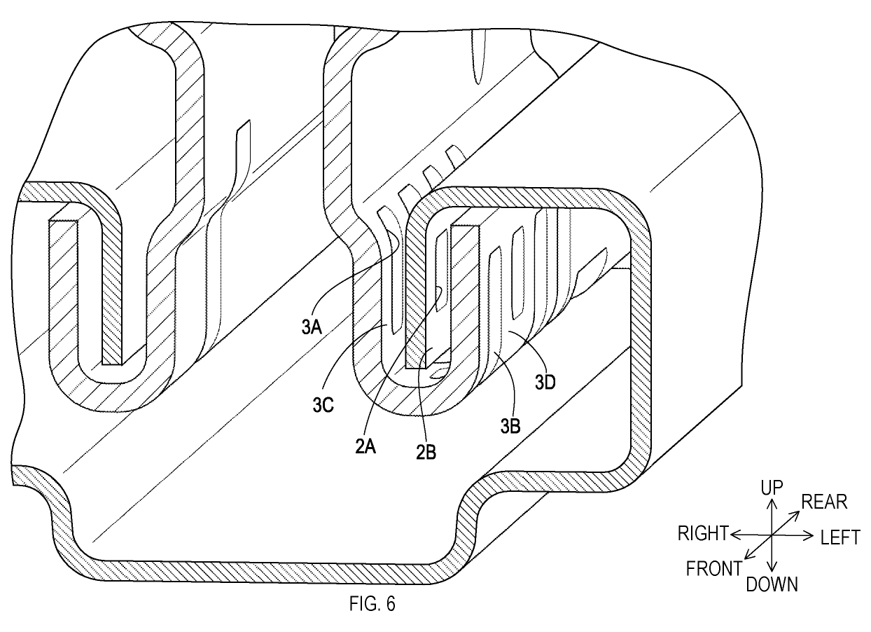

As shown in FIG. 5, engagement holes 3A and 3B are respectively provided in portions 3C and 3D of the movable rail 3 that face the fitting portion 2B. Specifically, as shown in FIG. 6, the engagement holes 3A are provided in the portion 3C located on one of both sides (on right side in FIG. 6) of the fitting portion 2B.

The engagement holes 3B are provided in the portion 3D located on the other side of both sides (on left side in FIG. 6) of the fitting portion 2B. When the locking mechanism 4 is located in the locked state, positions of respective face centers of the engagement holes 3A and 3B and the fitting holes 2A are aligned in the left-right directions. The “face center of a hole” refers to the center of a shape representing the outline of the hole.

As shown in FIG. 3, the locking mechanism 4 comprises at least a first latch 41, second latches 42, a first spring 44, a second spring 45, and the like. The first latch 41 and the second latches 42 are members coupled pivotably relative to the movable rail 3. The first latch 41 and the second latches 42 are coupled to the movable rail 3 via brackets 43. The brackets 43 are fixed to the movable rail 3.

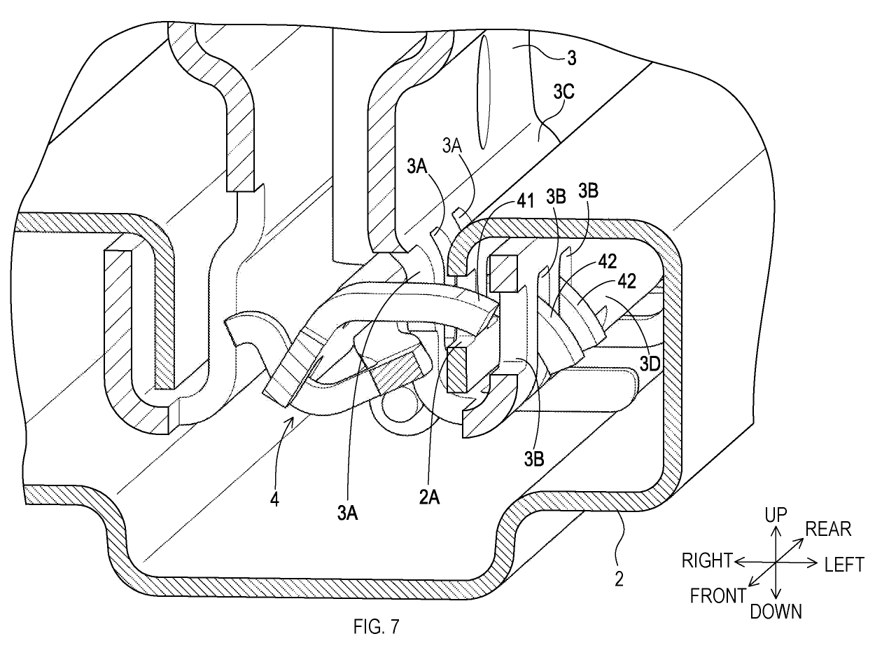

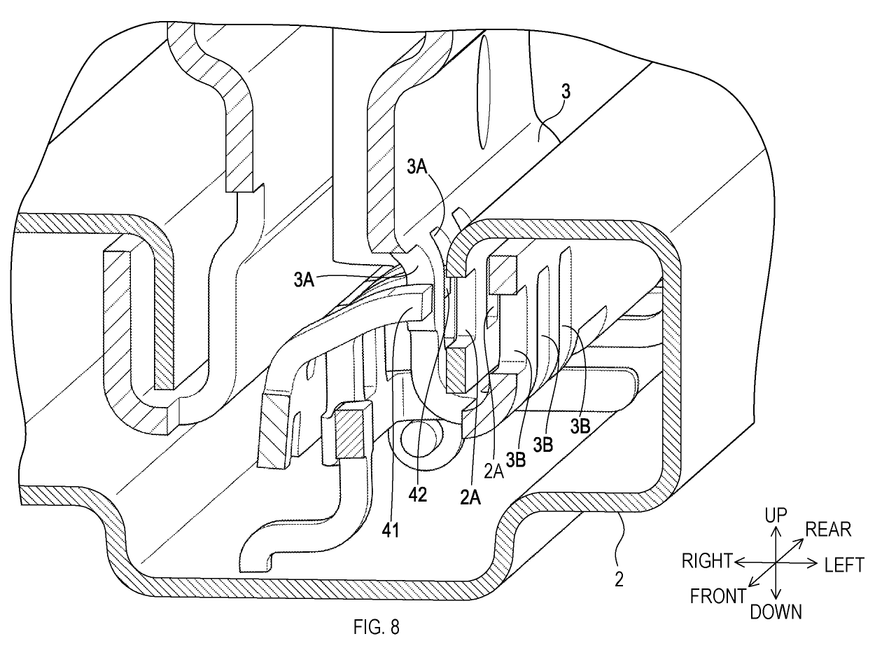

The first latch 41 is displaceable between the locked position where the first latch 41 engages with the fitting hole 2A (see FIG. 7) and an unlocked position where the first latch 41 is disengaged from the fitting hole 2A (see FIG. 8). As shown in FIG. 3, the first latch 41 is provided with an inclined portion 41A having a tapered shape.

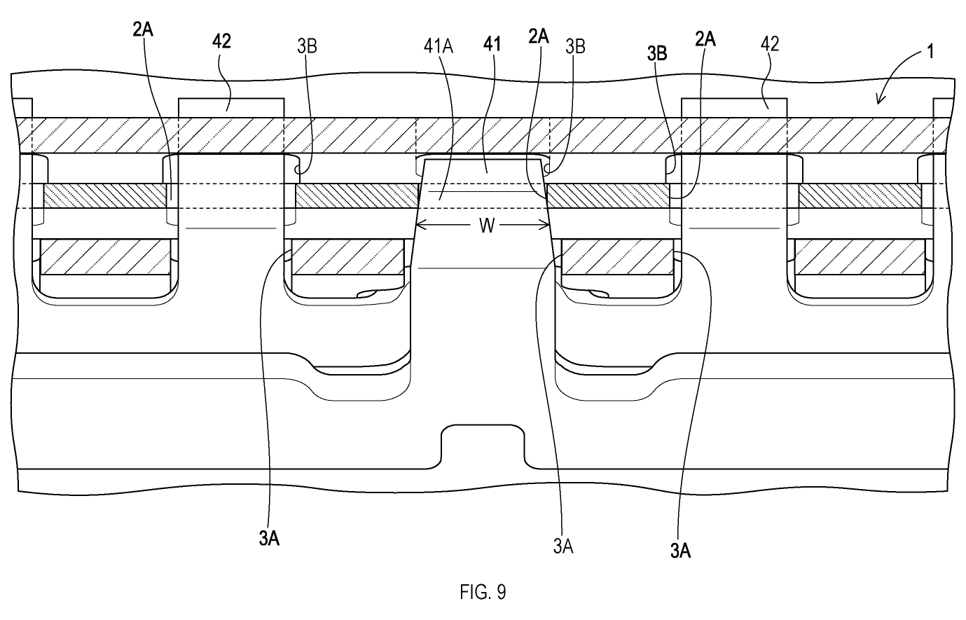

As shown in FIG. 9, the inclined portion 41A is a portion that is in contact with an inner circumferential surface of the fitting hole 2A when the first latch 41 is located in the locked position. That is, the inclined portion 41A is a tapered portion configured such that its width dimension W decreases toward a leading end side of the first latch 41.

The width dimension of the first latch 41 is a dimension of a portion parallel to a sliding direction of the movable rail 3. When the first latch 41 is located in the locked position, the first latch 41 penetrates the fitting hole 2A and the engagement hole 3A.

The second latches 42 are displaceable between locked positions (see FIG. 7) where the second latches 42 engage with the fitting holes 2A and unlocked positions (see FIG. 8) where the second latches 42 are disengaged from the fitting holes 2A. As shown in FIG. 9, when the second latches 42 are located in the locked positions, the second latches 42 penetrate the fitting holes 2A, the engagement holes 3A, and the engagement holes 3B.

The length of the first latch 41 is smaller than the length of each of the second latches 42, and when the second latch 42 is located in the locked position, a gap is formed between the second latch 42 and the inner circumferential surface of the fitting hole 2A, providing a non-contact state between the second latch 42 and the fitting hole 2A. Herein, “the length of the first latch 41 and the length of the second latch 42” refers to as a dimension in a direction perpendicular to the width direction.

A state in which “the length of the first latch 41 being smaller than the length of each second latch 42” provides a state in which “in the locked state, the first latch 41 penetrates the fitting hole 2A and the engagement hole 3A without completely penetrating the engagement hole 3B, and the second latch 42 penetrates the fitting hole 2A, the engagement hole 3A, and the engagement hole 3B”.

It is noted that, during a normal operation in which a significant external force does not act on the movable rail 3, the inclined portion 41A of the first latch 41 is in contact with the fitting hole 2A, thereby restricting a sliding movement of the movable rail 3.

When the significant external force acts on the movable rail 3, the inclined portion 41A and the fitting hole 2A are deformed such that the inclined portion 41A bites into the fitting hole 2A, and the second latches 42 are brought into contact with the engagement holes 3A and 3B, thereby restricting the sliding movement of the movable rail 3.

The second latches 42 are displaceable independently from the first latch 41. Specifically, as shown in FIG. 2, the first latch 41 is rotatably coupled to the brackets 43 via a first retaining portion 41B having a gate shape.

The second latches 42 are rotatably coupled to the brackets 43 via a second retaining portion 42A having a gate shape. As shown in FIG. 3, each of the brackets 43 is provided with a shaft 43A. The shaft 43A has an axial direction parallel to the sliding direction.

The shafts 43A support the first retaining portion 41B and the second retaining portion 42A such that each of the first retaining portion 41B and the second retaining portion 42A is rotatable between the locked position and the unlocked position. For this purpose, the first retaining portion 41B and the second retaining portion 42A are respectively provided with shaft holes 41C and 42B into which the shafts 43A fit (see FIG. 2).

As shown in FIG. 3, a portion 42C of the second retaining portion 42A where the shaft hole 42B is provided is located on an opposite side from the bracket 43 across a portion 42D of the first retaining portion 41B where the shaft hole 41C is provided.

The number of the first latch 41 is fewer than the number of the second latches 42. Specifically, the number of the first latch 41 is one, and the number of the second latches 42 is two or more. More specifically, at least one second latch 42 is provided on each of both sides of the first latch 41.

The first spring 44 exerts an elastic force (hereinafter, referred to as a “first retaining force”) for retaining the first latch 41 in the locked position. The second spring 45 exerts an elastic force (hereinafter, referred to as a “second retaining force”) for retaining the second latches 42 in the locked positions. The first retaining force is smaller than the second retaining force.

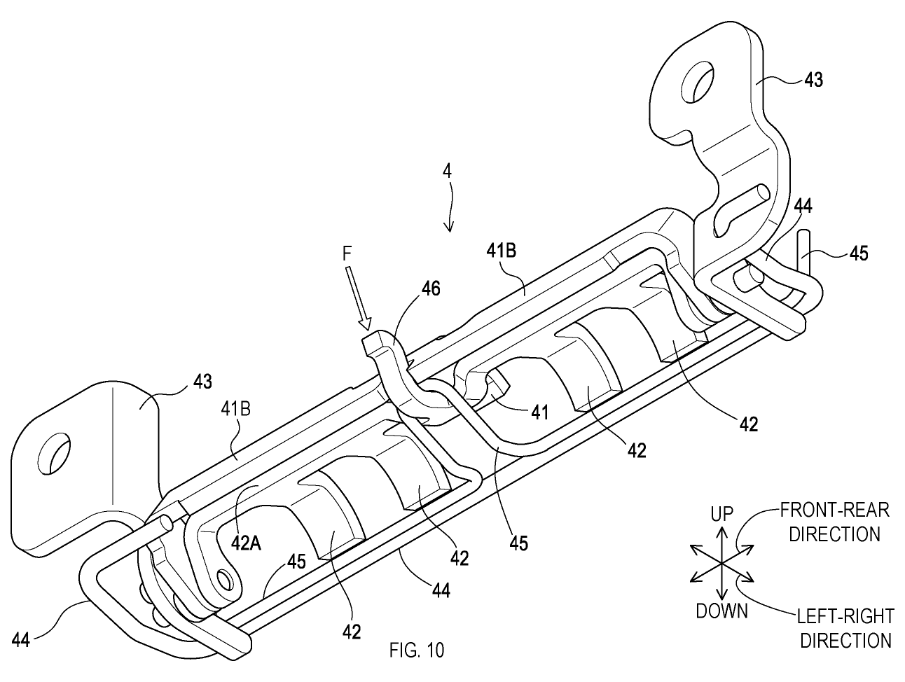

As shown in FIG. 10, each of the first spring 44 and the second spring 45 is a torsion bar utilizing torsional deformation of a wire rod. One end of the first spring 44 is engaged with the first retaining portion 41B, and the other end of the first spring 44 is engaged with the bracket 43.

Both ends of the second spring 45 are engaged with the movable rail 3, and a central portion of the second spring 45 is engaged with an operation lever 46 provided on the second retaining portion 42A. The operation lever 46 is a portion on which an operation force F acts when the first latch 41 and the second latches 42 are displaced to the unlocked positions.

The operation lever 46 is coupled to the second retaining portion 42A. In other words, the operation force F directly acts only on the second latches 42. It is noted that the operation force F is an operation force of an electric actuator (not shown) or a manual operation force of a user.

### Operation Of Locking Mechanism

### Lock Release Operation

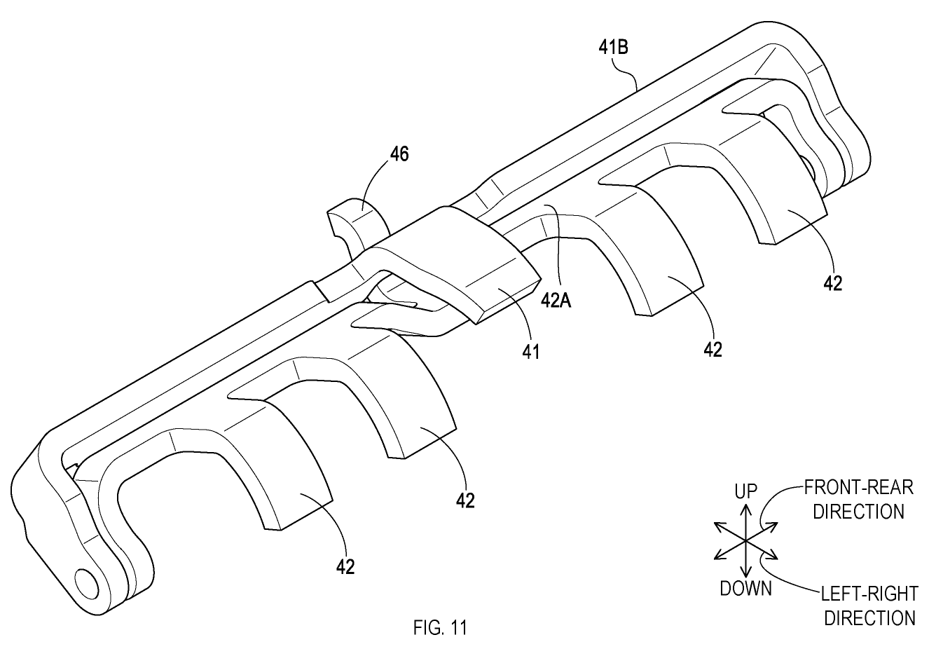

When the operation force F does not act on the operation lever 46, each of the first latch 41 and the second latches 42 are in the locked positions due to the elastic forces of the first spring 44 and the second spring 45 (see FIG. 11).

In this locked state, when the operation force F acts on the operation lever 46, only the second latches 42 are first displaced from the locked positions toward an unlocked position side. On the other hand, the first latch 41 remains in the locked position without being displaced.

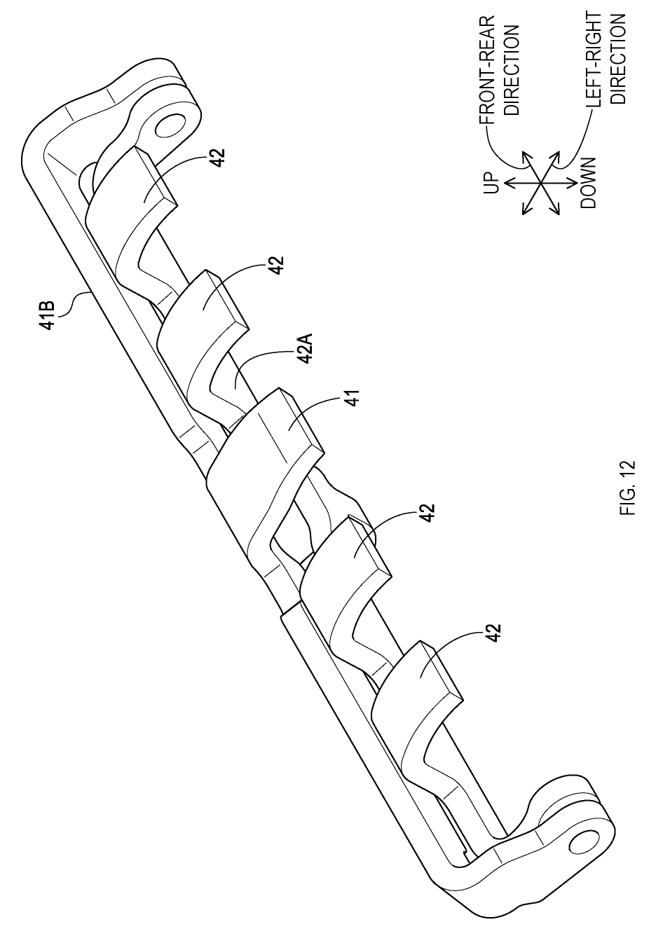

When only the second latches 42 are displaced from the locked positions to specific positions on the unlocked position side, the second retaining portion 42A or the second latches 42 are brought into contact with the first retaining portion 41B, as shown in FIG. 12. Accordingly, after this contact, the first latch 41 and the second latches 42 are displaced together toward the unlocked positions.

### Locking Operation

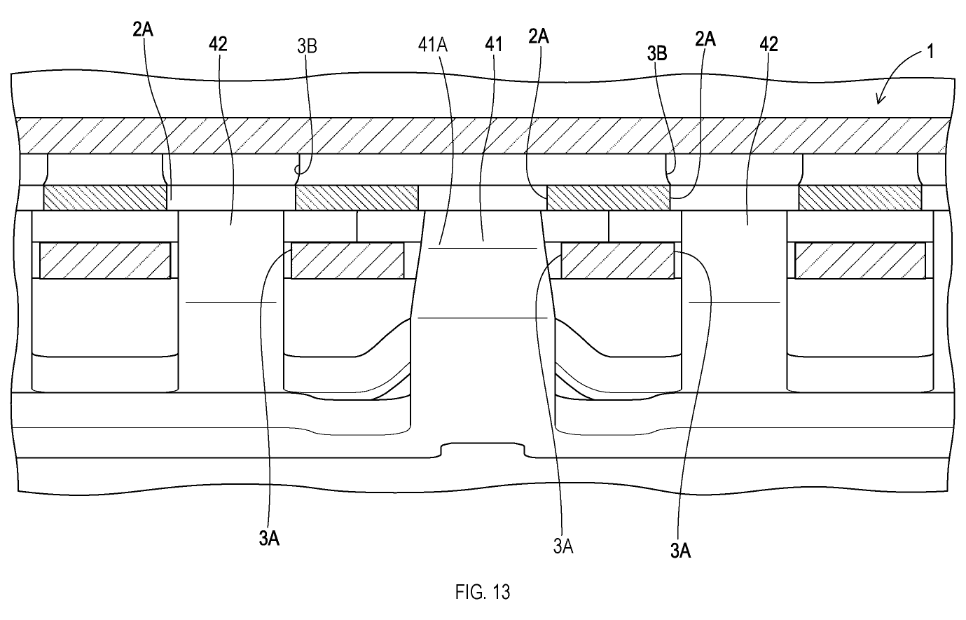

In the state in which the first latch 41 and the second latches 42 are located in the unlocked positions, when the operation force F is released, the first latch 41 and the second latches 42 are displaced together toward a locked position side (see FIG. 13).

At this time, in a case in which the positions of the face centers of the fitting holes 2A and the positions of the face centers of the engagement holes 3A and 3B coincide with each other in the left-right directions, the first latch 41 penetrates the fitting hole 2A and the engagement hole 3A, and the second latches 42 penetrate the fitting holes 2A, the engagement holes 3A, and the engagement holes 3B (see FIG. 9).

In a case in which the positions of the face centers of the fitting holes 2A and the positions of the face centers of the engagement holes 3A and 3B do not match in the left-right directions, a leading end of the first latch 41 and leading ends of the second latches 42 first strike against the fitting portion 2B, whereby the displacement stops temporarily.

Subsequently, when the movable rail 3 slides, the positions of the face centers of the fitting holes 2A and the positions of the face centers of the engagement holes 3A and 3B match in the left-right directions. As a result, the first latch 41 penetrates the fitting hole 2A and the engagement hole 3A, and the second latches 42 penetrate the fitting holes 2A, and the engagement holes 3A, and the engagement holes 3B (see FIG. 9).

### Features of Sliding Device According To Present Embodiment

In the sliding device 1 according to the present embodiment, the length of the first latch 41 is smaller than the length of each second latch 42, and when the second latch 42 is located in the locked position, the second latch 42 is in the non-contact state with the inner circumferential surface of the fitting hole 2A. This can reduce a displacement stroke of the first latch 41 in the sliding device 1.

Accordingly, entry speed of the first latch 41 can be small, and therefore, an impact when the first latch 41 enters the fitting hole 2A can be also small. Further, since the second latches 42 are not in contact with the inner circumferential surfaces of the fitting holes 2A, the impact when the second latches 42 enter the fitting holes 2A can be sufficiently small.

The number of the first latch 41 is smaller than the number of the second latches 42. This can reduce the mass of the member constituting the first latch 41, surely reducing the impact when the first latch 41 enters the fitting hole 2A.

The sliding device 1 comprises the brackets 43, which support the first latch 41 and the second latches 42 such that the first latch 41 and the second latches 42 are rotatable respectively, and which include the shafts 43A each extending in the sliding direction. This can reduce the number of the components of the sliding device 1 or suppress increase in the number of the components of the sliding device 1.

Moreover, the portion 42C of the second retaining portion 42A where the shaft hole 42B is provided is located on an opposite side from the bracket 43 across the portion 42D of the first retaining portion 41B where the shaft hole 41C is provided.

Thus, a large external force acting on the movable rail 3 is first input to the first retaining portion 41B via the brackets 43. Subsequently, after the first latch 41, the first retaining portion 41B, and the fitting hole 2A with which the first latch 41 engages are deformed, the external force is input to the second retaining portion 42A. As a result, an energy due to the large external force acting on the movable rail 3 can be reliably absorbed.

The first retaining force is smaller than the second retaining force. This can reduce the operation force for displacing the first latch 41 and the second latches 42 to the unlocked positions.

In addition, when the first latch 41 and the second latches 42 are displaced from the locked positions toward the unlocked position side, the second latches 42 are first displaced to the specific positions on the unlocked position side, and then, the first latch 41 and the second latches 42 are integrally displaced to the unlocked position side.

Thus, the operation force F required to displace the second latches 42 to the specific positions on the unlocked position side is only the force for overcoming the elastic force of the second spring 45. Accordingly, the operation force F can be reliably reduced.

### Other Embodiments

The movable rail 3 according to the above-described embodiment is provided with the engagement holes 3A and 3B. However, the present disclosure is not limited thereto. In one example, specifically, in the present disclosure, at least one of the engagement holes 3A or the engagement holes 3B may be omitted.

In the above-described embodiment, the number of the first latch 41 is smaller than the number of the second latches 42. However, the present disclosure is not limited thereto. In one example, specifically, in the present disclosure, it is sufficient that at least one first latch 41 and at least one second latch 42 be provided.

In the above-described embodiment, the portion 42C of the second retaining portion 42A where the shaft hole 42B is provided is located on the side opposite from the bracket 43 across the portion 42D of the first retaining portion 41B where the shaft hole 41C is provided. However, the present disclosure is not limited thereto. In one example, specifically, in the present disclosure, the arrangement of the portion 42C and the portion 42D may be reversed relative to the arrangement of the above-described embodiment.

In the above-described embodiment, the first retaining force is smaller than the second retaining force. However, the present disclosure is not limited thereto. In one example, specifically, in the present disclosure, the first retaining force and the second retaining force may be the same, or the first spring 44 and the second spring 45 may be replaced with a single spring exerting the functions of both of the first spring 44 and the second spring 45.

In the above-described embodiment, the second latches 42 are displaced to the specific positions on the unlocked position side, and then, the first latch 41 and the second latches 42 are integrally displaced to the unlocked position side. However, the present disclosure is not limited thereto.

In the above-described embodiment, the vehicle seat according to the present disclosure is applied to the automobile. However, the application of the disclosure disclosed herein is not limited thereto. Specifically, the present disclosure is also applicable to, for example, a seat used in vehicles, such as railroad vehicles, ships, or aircraft, and to a stationary seat used in theaters, homes, or other places.

Moreover, it is sufficient that the present disclosure be consistent with the spirit of the disclosure described in the above-described embodiments, and the present disclosure is not limited to the above-described embodiments. Therefore, a configuration may be employed in which at least two embodiments among the above-described embodiments are combined or in which any of the elements shown in the drawings or the elements described with reference numerals is omitted in the above-described embodiments.

What is claimed is:

1. A sliding device for slidably supporting a seat, comprising:
a fixed rail that is immovable and that is provided with two or more fitting holes arranged along a longitudinal direction;
a movable rail slidably coupled to the fixed rail and configured such that a seat is attachable to the movable rail;
a first latch coupled to the movable rail so as to be displaceable between a locked position where the first latch engages with first one of the fitting holes and an unlocked position where the first latch is disengaged from the first one of the fitting holes, the first latch including an inclined portion that has a tapered shape and that is brought into contact with an inner circumferential surface of the first one of the fitting holes when the first latch is located in the locked position;
at least one second latch coupled to the movable rail so as to be displaceable between a locked position where the second latch engages with second one of the fitting holes and an unlocked position where the second latch is disengaged from the second one of the fitting holes, the second latch being displaceable independently from the first latch;
a first spring configured to exert an elastic force for retaining the first latch in the locked position thereof; and
a second spring configured to exert an elastic force for retaining the second latch in the locked position thereof, wherein
a length of the first latch is smaller than a length of the second latch, and when the second latch is located in the locked position thereof, the second latch is not in contact with an inner circumferential surface of the second one of the fitting holes.

2. The sliding device according to claim 1, wherein
the movable rail includes a one-side portion and a different-side portion each facing a fitting portion, which is a portion of the fixed rail where the fitting holes are provided, from both sides of the fitting portion, the one-side portion and the different-side portion being respectively provided with engagement holes configured to allow the first latch and the second latch to penetrate,
when the first latch is located in the locked position thereof, the first latch penetrates the first one of the fitting holes and first one of the engagement holes in the one-side portion, and
when the second latch is located in the locked position thereof, the second latch penetrates the second one of the fitting holes, second one of the engagement holes in the one-side portion, and third one of the engagement holes in the different-side portion.

3. The sliding device according to claim 1, wherein
the first latch is smaller in number than the second latches.

4. The sliding device according to claim 1, further comprising a bracket fixed to the movable rail, the bracket including a shaft configured to support the first latch and the second latch such that the first latch and the second latch are individually rotatable between the locked positions thereof and the unlocked positions thereof.

5. The sliding device according to claim 4, further comprising:
a first retaining portion that is provided at the first latch and that includes a shaft hole through which the shaft passes, and
a second retaining portion that is provided at the second latch and that includes a shaft hole into which the shaft fits, wherein
a portion of the second retaining portion where the shaft hole of the second retaining portion is provided is located on a side opposite from the bracket across a portion of the first retaining portion where the shaft hole of the first retaining portion is provided.

6. The sliding device according to claim 1, wherein
the elastic force of the first spring for retaining the first latch in the locked position thereof is smaller than the elastic force of the second spring for retaining the second latch in the locked position thereof.

7. The sliding device according to claim 6, wherein
when the first latch and the second latch are displaced from the locked positions thereof to an unlocked position side, the second latch is first displaced to a specific position on the unlocked position side, and subsequently, the first latch and the second latch are integrally displaced to the unlocked position side.
